(19) United States
(12) Patent Application Publication
(10) Pub. No.: US 2008/0234920 A1
(43) Pub. Date: Sep. 25, 2008

(54) Remote Traffic Coordination and Control

(75) Inventor: Jukka K. Nurminen, Espoo (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/688,987

(22) Filed: Mar. 21, 2007

(51) Int. Cl. G06F 19/00

(52) U.S. Cl. 701/117

(57) ABSTRACT

A method is described that includes wirelessly transmitting from a mobile unit a traffic notification comprising information associated with a location of the mobile unit, and wirelessly receiving at the mobile unit a traffic instruction indicating whether or not to proceed. Also, a method is described that includes wirelessly receiving a traffic notification associated with a location of a mobile unit, determining a criterion associated with the traffic notification, evaluating the criterion, and wirelessly transmitting a first traffic instruction to the mobile unit to either proceed or not proceed based on an outcome of evaluating the criterion. Associated systems and devices are also described.

### BACKGROUND

Not all roads are created equal. Depending upon the materials, age, width, weather, usage, and other factors, roads can be quite fragile, extremely robust, or anywhere in between. For example, heavy vehicles can cause major damage to roads. While a particular road may survive decades of use by regular passenger cars, that same road may be damaged relatively quickly from use by eighteen-wheeler cargo transport trucks. Such damage occurs especially frequently on smaller roads, which are less apt to be able to handle the heavier vehicles.

Another factor that is co-mingled with vehicle weight is the frequency of vehicle use. In other words, the interval between vehicles can directly affect road lifetime. After a vehicle (especially a heavy vehicle) has passed, a road needs some time to recover. If insufficient time passes between heavy vehicles (e.g., five timber trucks drive one after another), then the road may immediately suffer permanent damage.

Conversely, if sufficient recovery time is provided between each of those five timber trucks (e.g., thirty minutes between each timber truck), then the road may suffer minimal or even no permanent damage. The necessary recovery time may depend upon any one or more of the above-mentioned factors, as well as vehicle weight, speed, and tire pressure.

### SUMMARY

In view of the above, it may be desirable to provide a way to regulate road usage to extend road lifetime and significantly reduce road maintenance costs without requiring a significant infrastructure overhaul. A system that functions as a virtual traffic light, and that in general helps to coordinate and/or control vehicular, pedestrian, and/or other traffic may be implemented. The system may define various alert areas that are relevant for traffic coordination. Mobile units such as vehicles may be equipped to detect and transmit traffic notifications alerting the system that they are in or near an alert area. The system may then respond by transmitting traffic instructions to the mobile units. These traffic instructions may instruct the mobile units to proceed or not proceed depending upon certain criteria associated with the relevant alert areas. The traffic instructions may include additional information as well.

To extend road lifetime, it may be sufficient that most heavy vehicles, for example, would be so equipped, whereas normal family cars are so light that they may not cause any problems to the roads. Where traffic control is desired without regard to road lifetime, then it may be desirable that most if not all vehicles are so equipped. It is noted that traffic control is not limited to vehicles. Any vehicles, pedestrians, and other objects may be remotely coordinated and/or controlled in this manner.

Various illustrative aspects are described herein. For example, according to some illustrative aspects, a method may be provided that includes wirelessly transmitting from a mobile unit a traffic notification comprising information associated with a location of the mobile unit, and wirelessly receiving at the mobile unit a traffic instruction indicating whether or not to proceed.

According to further illustrative aspects, an apparatus may be provided that includes a transmitter; a storage medium storing data representing a plurality of alert areas; and a controller coupled to the first receiver, the transmitter, and the storage medium, and configured to compare a location of the apparatus with the stored data, and to cause the transmitter to wirelessly transmit, responsive to an outcome of comparing, a traffic notification associated with the location.

According to still further illustrative aspects, an apparatus may be provided that includes means for determining a location of the apparatus; means for comparing the determined location with stored data representing a plurality of alert areas; and means for wirelessly transmitting a traffic notification associated with the determined location.

According to still further illustrative aspects, a method may be provided that includes wirelessly receiving a traffic notification associated with a location of a mobile unit; determining a criterion associated with the traffic notification; evaluating the criterion; and wirelessly transmitting a first traffic instruction to the mobile unit to either proceed or not proceed based on an outcome of evaluating the criterion.

According to yet further illustrative aspects, an apparatus may be provided that includes means for storing data associating a plurality of criteria with a plurality of alert areas; means for wirelessly receiving a traffic notification indicating one of the alert areas; means for determining one of the criteria associated with the indicated alert area; means for evaluating the determined criterion; and means for wirelessly transmitting either an indication to proceed or an indication not to proceed depending upon an outcome of evaluating the determined criterion.

According to yet further illustrative aspects, an apparatus may be provided that includes a computer-readable storage medium configured to store data associating a plurality of criteria with a plurality of alert areas; a receiver configured to wirelessly receive a traffic notification indicating one of the alert areas; a transmitter; and a controller coupled to the storage medium, the receiver, and the transmitter, and configured to determine one of the criteria associated with the indicated alert area, to evaluate the determined criterion, and to cause the transmitter to wirelessly transmit either an indication to proceed or an indication not to proceed depending upon an outcome of evaluating the determined criterion.

These and other aspects of the disclosure will be apparent upon consideration of the following detailed description of illustrative aspects. For example, illustrative systems including combinations and subcombinations of the above-mentioned apparatuses are described, as well as illustrative methods performed by these systems.

### BRIEF DESCRIPTION OF THE DRAWINGS

A more complete understanding of the present disclosure may be acquired by referring to the following description in consideration of the accompanying drawings, in which like reference numbers indicate like features, and wherein:

FIG. 1 is an illustrative plan view of a set of roads with a visual representation of two alert areas.

FIG. 2 is an illustrative plan view of a road intersection with a visual representation of three alert areas.

FIG. 3 is an illustrative functional representation of mobile devices communicating with a remote traffic control system.

FIG. 4 is an illustrative functional block diagram of a fixed portion of a remote traffic control system.

FIG. 5 is an illustrative functional block diagram showing inputs to and outputs from a controller of a coordination and control portion of the remote traffic control system.

FIG. 6 is an illustrative functional block diagram of a mobile portion of a remote traffic control system.

FIG. 7 is an illustrative front view of a vehicle dashboard including a user interface for providing a user with status information from a remote traffic control system.

FIG. 8 is an illustrative table of data that may be used in connection with a remote traffic control system.

FIG. 9 is an illustrative flowchart showing steps that may be performed by a mobile portion of a remote traffic control system.

FIG. 10 is an illustrative flowchart showing steps that may be performed by a coordination and control portion of a remote traffic control system.

It is noted that the various drawings are not necessarily to scale.

### DETAILED DESCRIPTION

The various aspects summarized previously may be embodied in various forms. The following description shows by way of illustration various examples in which the aspects may be practiced. It is understood that other examples may be utilized, and that structural and functional modifications may be made, without departing from the scope of the present disclosure.

Except where explicitly stated otherwise, all references herein to two elements being “coupled” to each other is intended to include both (a) the elements being directly connected to each other, or in direct communication with each other, without any intervening elements as well as (b) the elements being indirectly connected to each other, or in indirect communication with each other, with one or more intervening elements.

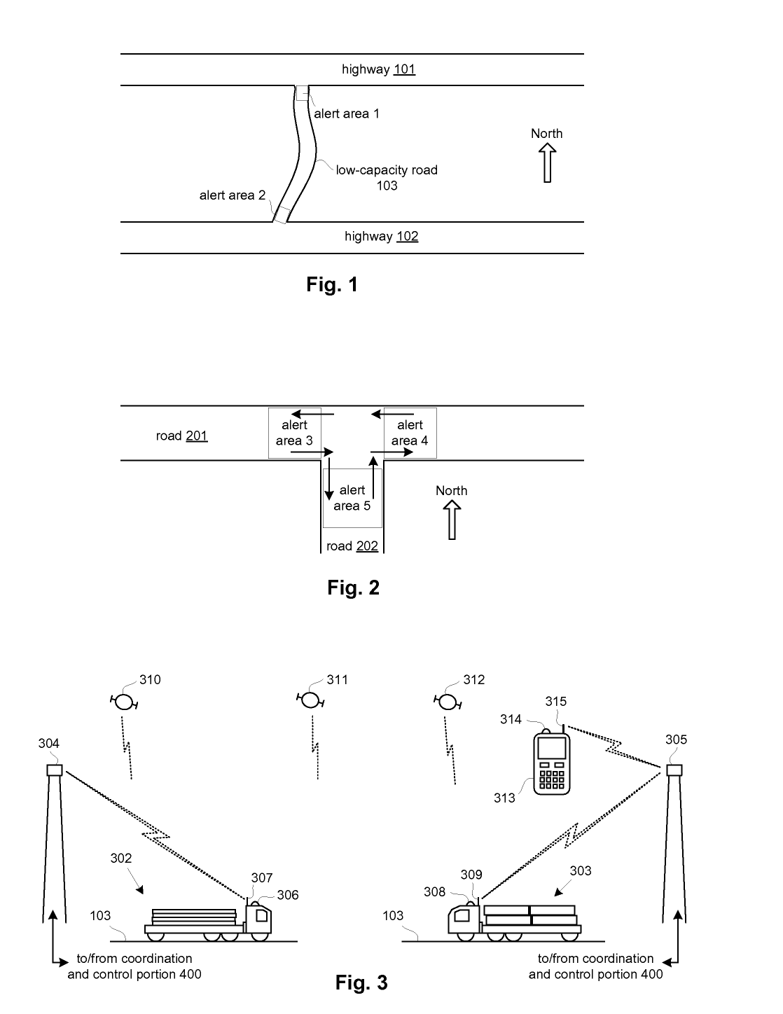

Referring to FIG. 1, an illustrative set of roads 101, 102, and 103 are shown. Roads 101 and 102 are highways (e.g., high-speed, limited-access roads), and road 103 is a relatively lower capacity road, such as a two-lane country road. It may be desirable to track and/or regulate usage of any of these roads 101-103. For example, because road 103 is more likely to be damaged than highways 101 and 102, and because it is fed by a potentially high volume of traffic from highways 101 and 102, it may be desirable to track and/or regulate the usage of road 103.

To do so, one or more alert areas may be defined, such as alert area 1 and alert area 2 as shown. These alert areas are not necessarily physically demarcated from regions outside the alert areas. Rather, these alert areas may simply be defined “on paper” (e.g., in a human-readable and/or computer-readable format) by one or more properties of the alert areas, such as the locations, sizes, and/or shapes of the alert areas. The various alert areas are represented in the figures of the present disclosure by shapes indicating the boundaries of the alert areas, however in reality these boundaries may not be marked with any physical indications. Alternatively, if desired, the alert areas may be physically indicated such as by physical markings on the road or signs near the road.

Although the alert areas are illustratively shown in the figures as having a generally square-shaped boundary, alert areas may be of any sizes or shapes. Also, although the alert areas are illustratively shown in the figures as being located at or near road intersections, alert areas may be located anywhere desired.

In the example of FIG. 1, alert area 1 is located at one end of road 103 adjacent to the interchange, intersection, or other junction of road 103 with highway 101, and alert area 2 is located at the other opposing end of road 103 adjacent to the interchange or other intersection of road 103 with highway 102. As will be described in more detail, an appropriately equipped vehicle may detect when the vehicle enters alert area 1 or 2 and notify a coordination and control portion (such as a centralized facility) of such entry. In response to this traffic notification, the coordination and control portion may notify the vehicle as to whether the vehicle is permitted to travel on road 103 or whether the vehicle must stop and/or wait to travel on road 103 at a later time. The coordination and control portion may take into account various factors in deciding whether to allow or disallow the vehicle, including but not limited to the particular alert area entered, the direction of vehicle travel, physical properties of the vehicle, the identity of the vehicle, properties of the road to be traversed, the priority of the vehicle (in which a higher priority may be obtained through, for example, payment of a fee) and/or historical usage of the road to be traversed.

In the example of FIG. 1, it may be desired, for instance, to enforce on road 103 at least a thirty-minute gap between vehicles weighing over twenty tons. Thus, for each appropriately-equipped vehicle weighing over twenty tons that notifies the coordination and control portion upon entry into alert area 1 or 2, the coordination and control portion may determine whether at least thirty minutes have passed since a vehicle weighing over twenty tons has traveled on road 103 in the same direction. In response to that determination, the coordination and control portion will either allow or disallow the requesting vehicle to continue travel on road 103.

In another example as shown in FIG. 2, a three-way intersection between roads 201 and 202 is shown. In this case, three alert areas 3, 4, and 5 are illustratively shown, each located adjacent to one side of the intersection. Thus, an alert area is provided for each direction of travel toward the intersection (there are three ways to travel into the intersection and three ways to travel out of the intersection, as indicated by the arrows).

In the example of FIG. 2, it may be desirable to set up a virtual traffic light at the intersection. In such a setup, the coordination and control portion may determine, for instance, that any vehicle in any of the alert areas 3, 4, or 5, will be granted passage through the intersection only if no other vehicles are in the intersection and no other vehicles traveling in a direction toward the intersection in alert areas 3, 4, or 5 have already been granted passage. To determine whether a vehicle is in the intersection even though it is no longer in an alert area, the vehicle may notify the coordination and control portion upon leaving its alert area. Alternatively or additionally, the coordination and control portion may assume that a vehicle has left an alert area, and/or that a vehicle is no longer in the intersection, after a predetermined amount of time has passed after the vehicle has notified that it has entered the alert area or upon notification of the vehicle that it has entered a different alert area.

Setting up such a virtual traffic light may be very easy and fast. Using a suitable user interface at the coordination and control portion, a user may simply select the locations of the alert areas and specify the criteria associated with them. There would be no need to visit the intersection physically, set up any equipment by the road, or provide energy for physical traffic lights. Also, the criteria for the alert areas might be set up such that different car classes might have different rules, allowing for finer granularity control of the traffic than conventional physical traffic lights that treat all vehicles equally. These potential advantages may also be realized in the example of FIG. 1.

Referring to FIG. 3, an illustrative system for implementing at least the examples of FIGS. 1 and 2 is shown at a high level. The system may be considered to have a remote portion that includes one or more mobile units 302, 303, and 313, and a fixed portion that includes one or more base stations 304 and 305 each coupled to a coordination and control portion 400.

In the present example, mobile units 302 and 303 are attached to or include vehicles, which in this case are trucks. Mobile unit 313 is a personal computing device such as a cellular phone and/or personal digital assistant (PDA). A mobile unit may be any device or system that is mobile and that is able to wirelessly communicate with one or more of base stations 304, 305. Each mobile unit may also be capable of determining its own location on Earth. Such self-location using any one or more locating technologies, such as but not limited to the Global Positioning System (GPS), radio triangulation, gyroscopes or other direct motion and/or position sensors, dead-reckoning, and/or fixed or mobile radio beacons.

In the specific example of FIG. 3, mobile units 302, 303, and 313 are each able to determine their respective locations based on receiving information from GPS satellites, such as GPS satellites 310, 311, 312. This information is received wirelessly via GPS antennas 306, 308, and 314, respectively, and processed by each mobile unit 302, 303, 313 accordingly to determine its location using known GPS techniques.

As will be described further, each mobile unit 302, 303, 313 may determine its location (such as by GPS), and determine whether that mobile unit is located within an alert area. In response to determining that it is indeed within an alert area, and possibly depending upon one or more other factors, the respective mobile unit 302, 303, 313 may notify coordination and control portion 400 via wireless communication with base station 304 or 305. In response, coordination and control portion 400 may determine a traffic instruction to provide to the notifying mobile unit, and provide the determined traffic instruction to that mobile unit via wireless communication from base station 304 or 305. Mobile units 302, 303, and 313 may each be able to wirelessly and bi-directionally communicate with base stations 304 and 305 using antennas 307, 309, and 315, respectively.

As an alternative to mobile units 302, 303, 313 determining for themselves whether they are in an alert area, coordination and control portion 400 may make this determination. In such a case, mobile units 302, 303, 313 may periodically or continuously send their locations to coordination and control portion 400 for comparison with stored alert area information. Also, as an alternative to self-location, coordination and control portion 400 may independently determine the locations of mobile units 302, 303, and 313. For example, mobile units 302, 303, and 313 may emit radio beacons that may be received and analyzed by coordination and control portion 400 to determine mobile unit location.

Base stations 304 and 305, as well as any other base stations in the system, may be geographically dispersed to provide wide wireless network coverage. For instance, base station 304 may be located near (and even within) alert area 1, and base station 304 may be located near (and even within) alert area 2. However, base stations do not necessarily need to be located an alert area. Although not necessary, it is expected that each mobile unit 302, 303, 313 may communicate with whichever base station 304 or 305 it is closest to or provides the strongest wireless link. Thus, mobile units 302, 303, and 313 may each communicate with the same base station or with different base stations, depending upon the particular locations of mobile units 302, 303, and 313 at any given time.

The wireless communication between mobile units 302, 303, 313 and base stations 304, 305 may use any wireless technology and information format desired. For example, such wireless communication may use existing cellular telephone communication technology and infrastructure, where base stations 304, 305 may be existing conventional cellular telephone network base stations or newly added base stations. In such a case, information may be transferred using, e.g., Short Message Service (SMS). Alternatively, information may be transferred over a voice channel or another dedicated data channel. For example, a wireless local area network (WLAN) may be used as the upstream and/or downstream communication link between mobile unit 302 and coordination and control portion 400. A WLAN environment may be particularly useful for pedestrian traffic situations, such as in department stores or airports. However, these are merely examples; mobile units 302, 303, 313 may wirelessly communicate with coordination and control portion 400 using any technology and infrastructure desired.

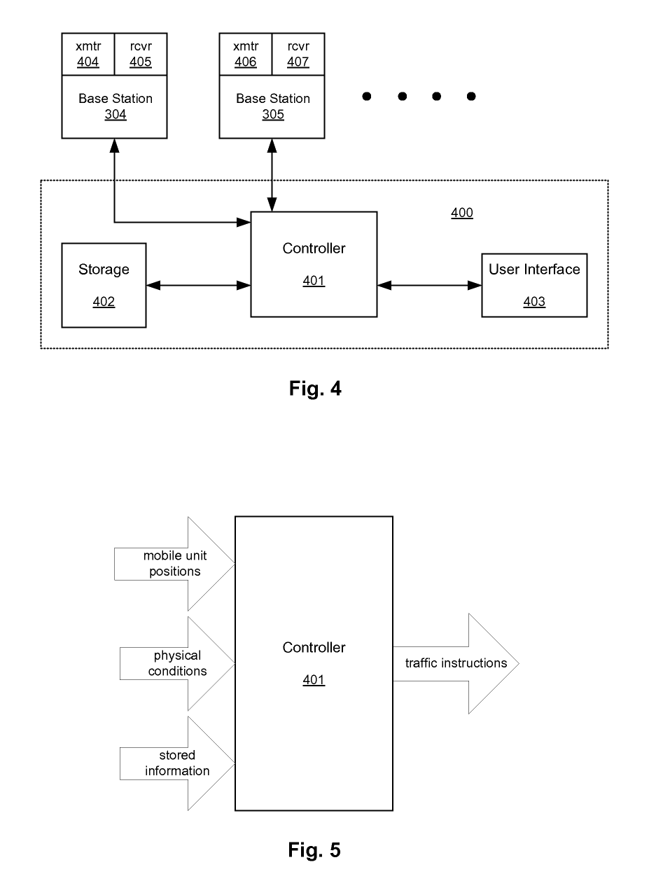

Referring to FIG. 4, an illustrative functional block diagram of the fixed portion of a remote traffic control system is shown, including coordination and control portion 400 and base stations 304 and 305 (as well as any other base stations). As shown, base station 304 includes at least one wireless transmitter 404 and at least one wireless receiver 405 for providing the bi-directional link with a mobile unit. Similarly, base station 305 includes at least one wireless transmitter 406 and at least one wireless receiver 407 for providing the bi-directional link with a mobile unit. Transmitters 404 and 406 may modulate information for wireless transmission, and receivers 405 and 407 may demodulate wireless transmissions to extract information. Base stations 304 and 305 (as well as any other base stations) may each be coupled to coordination and control unit 400 in any manner desired, such as but not limited to a landline telephone network, a dedicated wired data connection, a satellite link, a terrestrial wireless link, and/or the Internet.

Coordination and control portion 400 may include a controller 401, storage 402, and/or a user interface 403, all coupled together as shown. Controller 401 may be embodied as, for instance, one or more processors, interfaces, and/or other circuitry, which may be part of a computer system such as a server or personal computer. Controller 401 may be implemented in hardware, firmware, and/or software, and may include one or more of any of the other elements described with respect to FIG. 4. Where software is part of the implementation of controller 401, controller 401 may include or be coupled to one or more tangible computer-readable media storing the software as computer-readable instructions. Examples of computer-readable media include, but are not limited to, memory, a magnetic disk or tape, and/or an optical disk such as a compact disc (CD) or digital video disc (DVD).

Storage 402 may also be embodied as or otherwise include one or more computer-readable media, and may store the computer-executable instructions mentioned previously and/or non-executable data. The computer-executable instructions may partially or fully control the operations described herein of controller 401. Storage 402 may further include a device for reading from and/or writing to the computer-readable media, such as but not limited to a hard disk drive, a removable disk drive (e.g., a CD drive) and/or a tape drive.

User interface 403 may be embodied as any one or more user input and/or output devices, such as but not limited to one or more computer workstations, personal computers, displays, keyboards, etc. Information and/or commands may be transferred between user interface 403 and controller 401. User interface 403 may be in the same physical location as, or remotely from, the remainder of coordination and control portion 400. For instance, an authorized person may be able to program or otherwise control coordination and control portion 400 from user interface 403 via the Internet or another network.

FIG. 4 is intended only as an illustrative functional block diagram, and not as an indication of whether certain functions are physically unified with or separate from each other. For instance, controller 401, storage 402, and user interface 403 are illustrative only and may each be embodied as a single centralized unit or as distributed multiple units. In addition, coordination and control portion 400 may be located, for example, at a single central facility or scattered among a plurality of networked facilities in different locations. Moreover, although arrows are shown indicating particular functional connections, the actual physical connectivity may be quite different. For instance, a centralized bus structure may be implemented.

Referring to FIG. 5, illustrative inputs to and outputs from controller 401 are shown. In this example, controller 401 may receive mobile unit location information indicating the positions of the various mobile units 302, 303, 313, and in response controller 401 may produce a traffic instruction that is wirelessly sent to the appropriate mobile unit(s) 302, 303, 313. This location information may be an absolute location, such as a particular latitude and longitude, or it may be an identification of a geographical region, a road, an intersection or some other geographical feature, or an identification of an alert area (e.g., alert area 2).

Controller 401 may further receive information regarding any physical conditions measured by the various mobile units 302, 303, 313. For instance, it may be desirable to know the actual weight of truck 302 or 303 in order to have feedback on the amount of stress placed on road 103. As will be discussed further, each mobile unit 302, 303, 313 may have one or more sensors for sensing physical conditions, such as road conditions, environmental (e.g., weather) conditions, and/or conditions of a vehicle associated with the mobile unit, and information regarding these physical conditions may be wirelessly sent to controller 401 in the same way that traffic notifications of alert area entry are sent from mobile units 302, 303, 313.

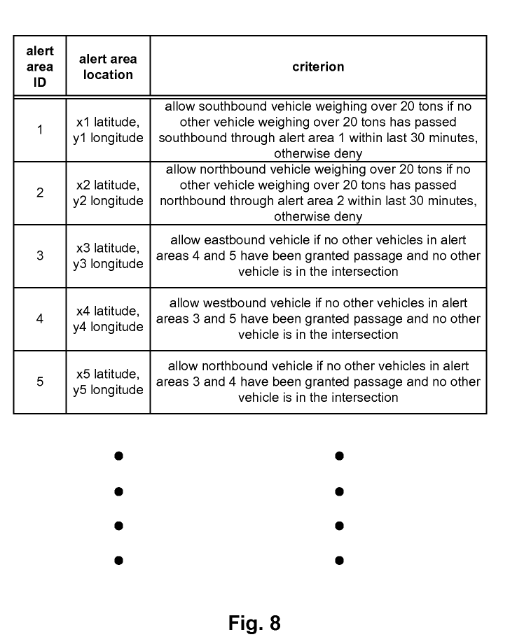

Controller 401 may further have access to information stored in storage 402. This stored information may include a database or other organization of data that allows controller 401 to make decisions based on information provided from mobile units 302, 303, 313. An example of information that may be stored is shown in FIG. 8. As can be seen, the information of FIG. 8 provides, for each alert area, a location of the alert area (e.g., in latitude and longitude), and a criterion for making a decision. Since an alert area is an area and not merely a single point, the location of the alert area may be considered, for instance, as the center of the alert area, a corner of the alert area, or any other reference point within or relative to the alert area. Other information defining the alert area may also be stored, such as the amount of area of the alert area, the alert area shape (e.g., circular, rectangular, etc.), the boundaries of the alert area, etc. It should be noted that the information stored in storage 402 may include only a subset of the information shown in FIG. 8 or more than shown in FIG. 8. Information such as that of FIG. 8 may be entered, for instance, manually via user interface 403 and/or automatically via receipt of portable computer-readable media such as CDs or magnetic disks.

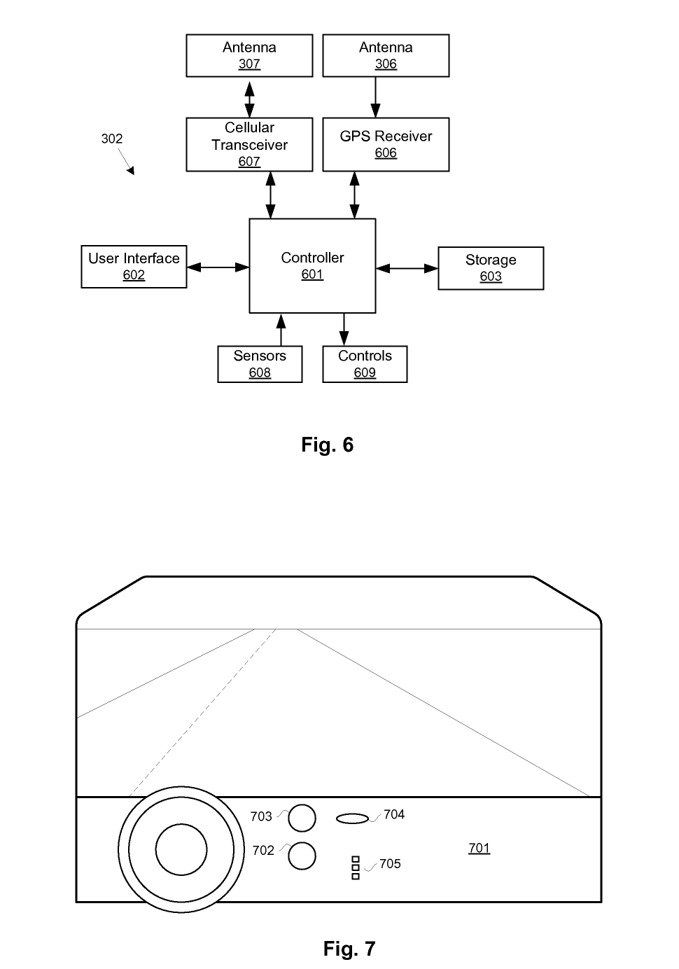

Referring to FIG. 6, an illustrative functional block diagram of mobile unit 302 is shown. In this example, mobile unit 302 has a controller 601 coupled to a user interface 602, one or more sensors 608, one or more controls 609, storage 603, a cellular transceiver 607 (which includes both a wireless receiver and transmitter), a GPS receiver 606, and antennas 306 and 307. FIG. 6 is intended only as an illustrative functional block diagram, and not as an indication of whether certain functions are physically unified with or separate from each other. In addition, although arrows are shown indicating particular functional connections, the actual physical connectivity may be quite different. For instance, a centralized bus structure may be implemented. Some or all of the elements of FIG. 6 may be considered part of mobile unit 302. In the case of mobile unit 302 being a vehicle, some or all of the elements of FIG. 6 may be located on board the vehicle.

Controller 601 may be embodied as, for instance, one or more processors, interfaces, and/or other circuitry, which may be part of a computer system such as a server or personal computer or part of a GPS navigation system, and may include one or more of any of the other elements described with respect to FIG. 6. It is estimated that most cars will be equipped with GPS navigation systems by 2010, and many are already.

Controller 601 may be implemented in hardware, firmware, and/or software. Where software is part of the implementation of controller 601, controller 601 may include or be coupled to one or more computer-readable media storing the software as computer-readable instructions. Example of computer-readable media include, but are not limited to, memory, a magnetic disk or tape, and/or an optical disk such as a compact disc (CD) or digital video disc (DVD).

Storage 603 may also be embodied as or otherwise include one or more computer-readable media, and may store the computer-executable instructions mentioned previously and/or non-executable data. The computer-executable instructions may partially or fully control the operations described herein of controller 601. Storage 603 may further include a device for reading from and/or writing to the computer-readable media, such as but not limited to a hard disk drive, a removable disk drive (e.g., a CD drive) and/or a tape drive. Storage 603 may further store alert area information such as some or all of the information shown in FIG. 8. This alert area information stored in storage 603 may be updated via updates received from coordination and control portion 400 via the wireless connection with one or more of base stations 304, 305. The updates may be pushed to the mobile units in response to modifications to information regarding alert areas (such as a modification to the stored information of FIG. 8), or periodically, or on any other basis. In this way, alert area information stored in storage 603 may be consistent with alert area information with which coordination and control portion 400 is operating.

User interface 602 may be embodied as any one or more input and/or output interfaces suitable for interacting with a user, such as but not limited to one or more computer workstations, personal computers, displays, keyboards, buttons, lights, speakers, etc. In the case of mobile unit 302 being a vehicle, user interface 602 may be at least partially located within reach of the driver, such as on the dashboard or steering wheel of the vehicle. Information and/or commands may be transferred between user interface 602 and controller 601.

Sensors 608 may be embodied as any one or more sensors that sense physical phenomena other than location. For instance, where mobile unit 302 is a vehicle, sensors 608 may include sensors that detect parameters that may be relevant to stress placed on road 103 by the travel of the vehicle, such as a vehicle speed sensor, a vehicle direction of travel sensor, a temperature sensor, a humidity sensor, a rain sensor, and/or sensors that sense a physical force, such as a vehicle weight sensor, a vehicle suspension force sensor, and/or a tire pressure sensor. Information from sensors 608 may be provided to controller 601 to be considered when evaluating criteria in making a traffic instruction decision.

Controls 609 may be embodied as any one or more devices that control operation of mobile unit 302. For instance, where mobile unit 302 is a vehicle, controls 609 may include devices that disable the engine and/or transmission of the vehicle. This may be useful where it is desirable to provide a capability to enforce decisions made by coordination and control portion 400. Devices includes in controls 609 may be controlled by commands from controller 601. For example, rather than instructing mobile unit 302 not to proceed, coordination and control portion 400 may instruct the vehicle that it may proceed provided that it modifies one or more physical properties associated with mobile unit 302, such as vehicle tire pressure. In response, controller 601 may cause controls 609 to reduce or increase vehicle tire pressure as appropriate (or modify some other physical property). Thus, coordination and control portion 400 may not only be able to control gaps between vehicles and intersections, but also to directly or indirectly (e.g., with or without approval by the mobile unit user, such as the vehicle driver) the physical characteristics of the mobile units.

In the example shown, antenna 307 is coupled to cellular transceiver 607, and thus in this example communications between mobile unit 302 and base stations 304 and 305 is via cellular telephony. However, transceiver 607 may be another type of wireless transceiver as desired. Transceiver may module outgoing signals with data provided from controller 601 and may demodulate incoming signals to provide data to controller 601. GPS receiver 606 may provide an interface between controller 601 and GPS antenna 306. GPS receiver 606 may further pre-process incoming GPS signals before providing GPS information to controller 601. Although a GPS receiver and antenna are used in the illustrated example, other types of locating technology may be alternatively or additionally used. For example, instead of GPS receiver 606 and GPS antenna 306, mobile unit 302 may have a different type of antenna couple to a triangulation device, and/or a compass and/or gyroscope.

FIG. 7 is an illustrative view of a cockpit of the vehicle of mobile unit 302, from the point of view of the driver. As shown, a dashboard 701 may include one or more user indicator devices, such as lights 702 and 703 and speaker 704. Dashboard 701 may further include one or more user input devices, such as buttons 705. Lights 702 and 703, speaker 704, and buttons 705 may all be considered part of user interface 602. In the present example, lights 702 and 703 may be of different colors, such as green and red, to indicate different traffic instructions provided by control and coordination portion 400. For instance, illumination of a green light 702 may indicate to the driver that coordination and control portion 400 has instructed that it is okay to proceed, whereas illumination of a red light 703 may indicate to the driver that coordination and control portion 400 has instructed that it is not okay to proceed.

Speaker 704 may further be used to provide the same or additional information, such as by providing different sounds depending upon the particular traffic instruction provided by coordination and control portion 400 (e.g., a buzzer means that it is not okay to proceed, whereas a friendly beep or the lack of a sound means that it is okay to proceed). In addition or alternatively, a computer display may be included to provide the driver with detailed information about road status and/or traffic instructions from coordination and control portion 400.

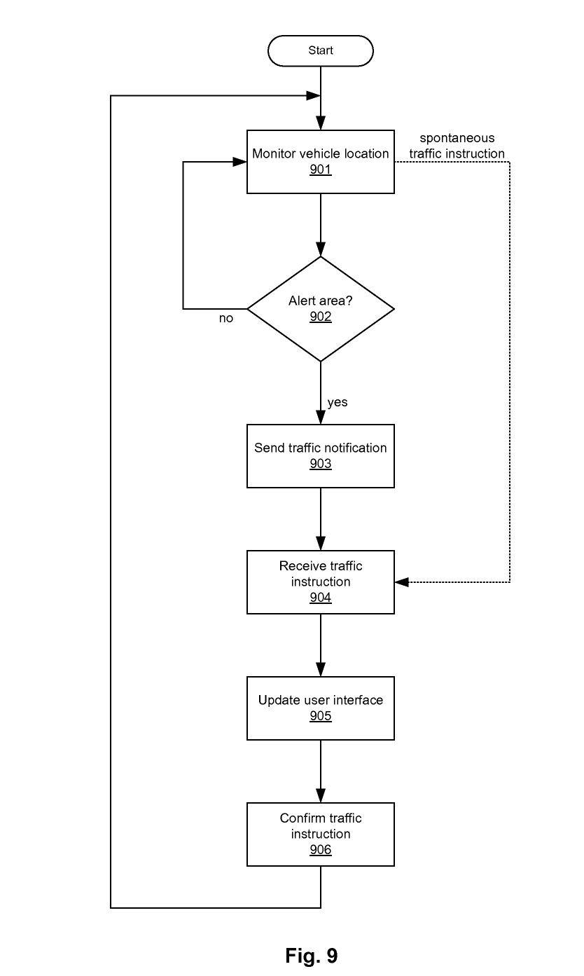

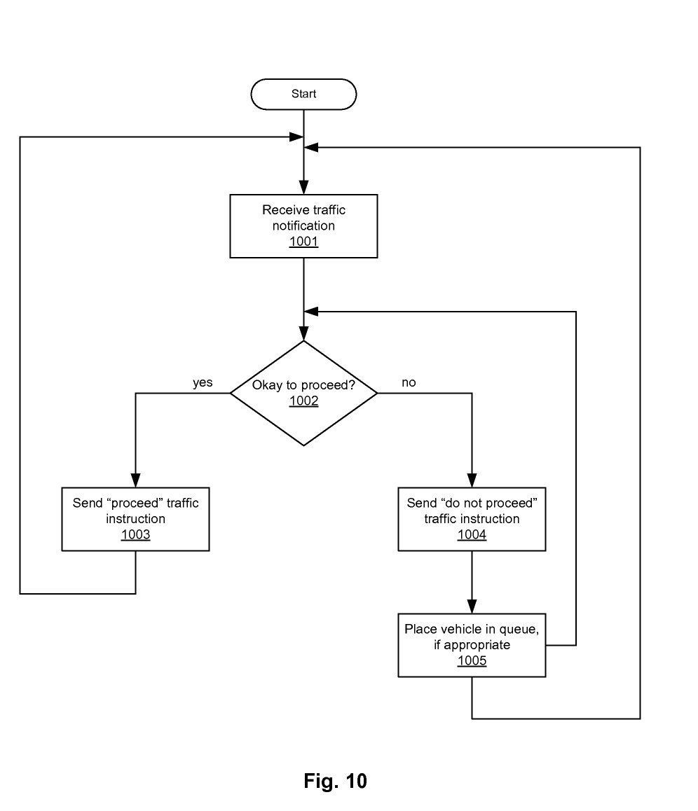

FIGS. 9 and 10 are now described together to provide examples of operation of the remote traffic control system. FIG. 9 is an illustrative flowchart showing steps that may be performed by mobile unit 302, and FIG. 10 is an illustrative flowchart showing steps that may be performed by coordination and control portion 400. However, the separation of steps as shown is merely illustrative; any of the steps may be performed by mobile unit 302 and/or coordination and control portion 400, as desired. For instance, it may be desirable that coordination and control portion 400 perform more of the decision-making steps (and thus less steps performed by mobile unit 302), to reduce the cost, size, weight, and power consumption of mobile unit 302. On the other hand, where mobile unit 302 is smarter (e.g., the more steps performed by mobile unit 302), this may allow the amount of information transmitted between mobile unit 302 and coordination and control portion 302 to be reduced, thereby reducing overall bandwidth load on the wireless network.

In step 901, controller 601 continuously or periodically monitors and determines the current location of the vehicle that it is a part of, using information provided by GPS antenna 306 and GPS receiver 606. Controller 601 further compares the current location with a list of known alert areas to determine whether the vehicle is in an alert area (step 902). For instance, controller 601 may determine whether the current location matches the location of an alert area or whether the current location is within the area of an alert area. To make this comparison, controller 601 may compare the current location provided from GPS receiver 606 with alert area information retrieved from storage 603. This alert area information may have been previously stored in response to receiving a wireless transmission, and any subsequent updates, of the alert are information from coordination and control portion 400 via antenna 307 and transceiver 607.

In response to determining that the vehicle is within an alert area, controller 601 may cause cellular transceiver 607 to transmit over antenna 307 a traffic notification of which alert area the vehicle is in (step 903), depending upon certain factors. For instance, if it is determined that alert area 1 is entered, then controller 601 may further determine whether a criterion associated with alert area 1 is met. If so, then the traffic notification is sent. If not, then the traffic notification is not sent. In the present example of alert area 1, the associated criterion is shown in FIG. 8 as “allow southbound vehicle weighing over 20 tons if no other vehicle weighing over 20 tons has passed southbound through alert area 1 within last 30 minutes, otherwise deny.” Of course, this criterion (and the remaining information of FIG. 8, for that matter) is described in the present disclosure in plain language, however in actual implementation the criterion may be written in more computer-friendly format. Thus, controller 601 may determine from sensors 608 or stored information whether the vehicle weighs over 20 tons and whether the direction of travel of the vehicle is southbound. If it is determined that the vehicle is southbound, weighs over 20 tons, and is in alert area 1, then controller 601 may cause the traffic notification to be transmitted in step 903. Otherwise, the traffic notification may not be sent and the process returns from step 902 to step 901.

Alternatively, step 903 may be performed without any pre-processing of a criterion. For instance, controller 601 may cause cellular transceiver 607 to always transmit over antenna 307 the traffic notification upon detection of entry into an alert area, regardless of the direction of travel or weight of the vehicle or any other factor. Instead, this criterion may be evaluated solely at coordination and control portion 400. While this alternative may potentially increase the amount of information transmitted between mobile unit 302 and coordination and control portion 400, this may also allow mobile unit 302 to be made less complex.

The traffic notification may include an identification of the alert area (e.g., “alert area 1”), an indication of a unique identifier of the mobile unit transmitting the traffic notification, and/or information provided from or derived from sensors 608, such as vehicle weight, direction of travel, etc.

In response to the transmitted traffic notification, coordination and control portion 400 receives the traffic notification (step 1001, FIG. 10) via base station 304 and/or 305, and the traffic notification is forwarded to controller 401. Next, controller 401 determines whether it is okay for the notifying mobile unit (in this case, mobile unit 302) to proceed (step 1002). To perform this determination, controller 401 may evaluate the criterion stored in storage 402 and associated with the identified alert area to the received traffic notification as well as other information in storage 402 regarding the status of other mobile units, current road conditions (such as indicated by road condition feedback included in traffic notifications from the various mobile units that include sensors affected by road conditions), and/or other factors relevant to determination of the whether the criterion requirements are met. Where mobile unit 302 includes information about the weight of the vehicle, vehicle tire pressure, vehicle direction of travel, and/or other characteristics of mobile unit 302 in the traffic notification, then controller 401 may use this received information in its determination. For instance, controller 401 may store in storage 402 a status of the conditions of various roads, and these road conditions may be updated based on road condition feedback provided in the traffic notifications. These stored road conditions may be evaluated as part of the criteria in determining a traffic instruction. Alternatively, where such information is not included in the traffic notification, then controller 401 may assume that the vehicle weight and direction of travel criteria have been met, otherwise the traffic notification would not have been sent in the first place (since such initial criterion determination would already have been performed by mobile unit 302 prior to transmitting the traffic notification). Alternatively, or in addition, depending on road condition and/or vehicle condition feedback received from the mobile units included in the traffic alerts, the size of the alert areas may be adjusted. For example, a larger alert area may be desired during wet conditions or while road is slippery.

If it is determined in step 1002 that the associated criterion results in a decision to proceed, then controller 401 causes base station 304 and/or 305 to transmit a traffic instruction to proceed to mobile unit 302 (step 1003). However, if it is determined in step 1002 that the associated criterion results in a decision not to proceed, then controller 401 causes base station 304 and/or 305 to transmit a traffic instruction not to proceed to mobile unit 302 (step 1004). The traffic instruction to proceed or not proceed may include an identification of the mobile unit to which it is directed, a time stamp, and identification of the alert area to which it pertains, and/or any other information deemed useful.

Referring back to FIG. 9, in step 904, mobile unit 302 receives the transmitted traffic instruction via antenna 307, demodulates the transmission to extract the traffic instruction at transceiver 607, and forwards the traffic instruction to controller 601 for further action. Controller 601 then causes user interface 602 to indicate to the user (in this case, the driver) of the traffic instruction (step 905). For instance, if the traffic instruction is to proceed, then controller 601 may cause green light 702 to illuminate. Or, if the traffic instruction is not to proceed, then controller 601 may cause red light 703 to illuminate. Another possibility is that no traffic instruction or other type of feedback is received at all by mobile unit 302. In such a case, mobile unit 302 may repeat the traffic notification, or may by default respond as though the traffic instruction were not to proceed, or indicate to the mobile unit user that no response has been received so that the user can decide what to do. Controller 601 may further send a confirmation of the traffic instruction back to coordination and control portion 400 via transceiver 607 and antenna 307, so that coordination and control portion 400 knows that the traffic instruction has been successfully received. Then, the process returns to step 901 for further location monitoring.

Referring again to FIG. 10, if the traffic instruction was “do not proceed,” then controller 401 may place mobile unit 302 in a queue, or otherwise place mobile unit 302 on hold to await a future “proceed” traffic instruction, if desired (step 1005). Periodically, or in response to some status change, controller 401 may move the process back to step 1002 for mobile unit 302 to determine whether it is now okay to proceed. If so, then controller 401 may cause a proceed traffic instruction (step 1003) to be transmitted to mobile unit 302 via base station 304 and/or 305. Such an unscheduled, or spontaneous, traffic instruction, may be handled by controller 601 of mobile unit 302 by sending the process to step 904 for processing of the traffic instruction.

The above-described concepts are not limited to coordinating and/or controlling land vehicular traffic (e.g., trucks, cars, buses, and trains), but may also be used to coordinate and/or control the movement of any type of manned or unmanned vehicle or other object, such as but not limited to water vehicles (e.g., boats), air vehicles (e.g., airplanes and helicopters), pedestrians, and other objects with self-locating capabilities. For example, mobile unit 313 may be configured in the same manner as described previously with regard to mobile unit 302, especially with regard to FIGS. 6 and 9. Thus, persons having a properly equipped mobile unit such as mobile unit 313 may also be coordinated in a similar manner. This may be particularly useful in aiding in crowd control or notifying persons that they are entering an area in which they should not be or for queue management, such as in stadiums, department stores, and airports. In addition, traffic instructions are not limited to indicating either to proceed or not to proceed, but may additionally or alternatively contain other indications, such as an indication to turn in a particular direction (e.g., left, right, north, west, etc.), to maintain a particular speed or stay within a particular speed minimum and/or maximum, to wait an indicated amount of time or until a particular time of day, to move to a particular location (e.g., go to the kitchen department, go to a certain checkout point, or take the next exit), and/or informative indications such as a bad weather warning.

For example, in the environment of a department store, an indoor locating system may be implemented whereby a user's mobile unit may self locate within the department store. Of course, other indoor locating systems may be used. The user may display a digital store directory using the mobile unit to learn that the toy department is located on the fourth floor. As the user proceeds towards the toy department, the mobile unit would monitor the user's location and notify the coordination and control portion whenever the user is entering or in a particular alert area, such as a stairwell or walkway intersection. In addition, the department store, via the coordination and control portion, may be able to collect data about how the various customers are moving inside the store, which may be valuable for, e.g., deciding where to locate advertising and merchandise, or for dynamically directing customers to suitable checkout points so that the estimated waiting time in lines may be reduced for the customers.

As another example, alert areas may be defined to help passengers of boats or other mass transit (e.g., train, bus, airplane, etc.) to find their way to the proper boat. In this example, alert areas may be tied to a passenger's electronic ticket for travel, such that the passenger's mobile unit knows whether the passenger is entering a proper or improper alert area based on the content of the ticket. For instance, sometimes there are long tubes through which the passengers walk to reach their boat. Taking a wrong turn (e.g., in contradiction of what is defined by the ticket) could lead a passenger to the wrong boat and/or require that the passenger retrace his or her steps by several hundred meters, all while carrying luggage. This wasted time may result in the passenger missing his or her boat. However, by implementing alert areas associated with the tube intersections or at other features such as stairs, the passenger may be notified as soon as the passenger takes the wrong turn.

The possibilities provided by such a traffic coordination and/or control system are virtually limitless. For instance, such a system may be used for pedestrian or vehicle queue control (e.g., only let N persons in to a certain place at a time). Or, such a system may be used to replace the traditional “occupied” sign in a restroom or other facility by sensing and responding to whether a user (or maximum number of users) is presently in the facility.

In addition, the above-described concepts need not require fixed alert areas, but instead alert areas may be dynamically created, moved, and deleted as the need arises and/or in response to a particular schedule. For instance, there is often a particular need to coordinate the traffic in response to changing needs such as in cases of road construction, accidents, parking lots, and during the congestion of rush hour commuting. These needs often occur in unexpected places and are needed for rather small periods of time. Updates of changes to the alert areas may be wirelessly transmitted to mobile units in real time as needed.

Moreover, coordination and control portion 400 may take into account other non-location-based context information when evaluating criteria leading to traffic instructions. For example, in a mall or airport system, the pedestrian mobile unit (e.g. a mobile phone or PDA) could send its location along with information regarding an action that the pedestrian has performed or a status of the pedestrian, such as an indication that the user has picked up a particular item. In response, coordination and control portion 400 may include this information in its evaluation in determining the appropriate traffic instruction. Another example is in an airport, where a traffic notification may include an indication that the pedestrian has successfully passed a security point, and in response coordination and control portion 400 may include in the traffic instruction information about how to proceed to the proper gate.

Thus, a system and method for remotely coordinating and/or controlling traffic of vehicles, people, and other items has been described.

What is claimed is:

1. A method, comprising:
wirelessly transmitting from a mobile unit a traffic notification comprising information associated with a location of the mobile unit; and
wirelessly receiving at the mobile unit a traffic instruction.

2. The method of claim 1, further comprising:
comparing the location of the mobile unit with data representing a plurality of alert areas,
wherein wirelessly transmitting includes wirelessly transmitting the traffic notification indicating which of the plurality of alert areas corresponds to the location.

3. The method of claim 2, wherein the data further includes a plurality of directions of travel associated with the plurality of alert areas.

4. The method of claim 3, further comprising determining a direction of travel of the mobile unit, and wherein comparing includes comparing the determined location and the direction of travel of the mobile unit with the stored data.

5. The method of claim 2, further comprising:
wirelessly receiving the data at the mobile unit; and
storing the data in a computer-readable medium.

6. The method of claim 5, further comprising:
wirelessly receiving an update to the stored data at the mobile unit; and
updating the stored data.

7. The method of claim 1, wherein wirelessly transmitting includes wirelessly transmitting the traffic notification indicating the location of the mobile unit.

8. The method of claim 1, further comprising:
providing one of a plurality of different possible physical indications depending upon the traffic instruction.

9. The method of claim 8, wherein a first one of the plurality of different possible physical indications includes emitting a first color, and a second one of the plurality of different possible physical indications includes emitting a different second color.

10. The method of claim 8, wherein the plurality of different possible physical indications includes emitting a sound.

11. The method of claim 1, further including determining the location of the mobile unit using a global positioning system (GPS) device.

12. The method of claim 1, further comprising determining a direction of travel of the mobile unit, wherein wirelessly transmitting includes wirelessly transmitting the traffic notification including an indication of the direction of travel.

13. The method of claim 1, wherein the traffic notification includes a representation of at least one of a vehicle weight and a vehicle tire pressure.

14. The method of claim 1, wherein wirelessly receiving includes wirelessly receiving at the mobile unit the traffic instruction indicating whether or not to proceed.

15. An apparatus, comprising:
a transmitter;
a storage medium storing data representing a plurality of alert areas; and
a controller coupled to the first receiver, the transmitter, and the storage medium, and configured to compare a location of the apparatus with the stored data, and to cause the transmitter to wirelessly transmit, responsive to an outcome of comparing, a traffic notification associated with the location.

16. The apparatus of claim 15, wherein the traffic notification comprises an indication of one of the alert areas.

17. The apparatus of claim 15, wherein the traffic notification comprises an indication of the location.

18. The apparatus of claim 15, wherein the controller is further configured to compare the location with the plurality of alert areas to determine whether one of the plurality of areas includes the location.

19. The apparatus of claim 15, further comprising:
a receiver coupled to the controller and configured to wirelessly receive a traffic instruction; and
an output interface coupled to the controller,
wherein the controller is further configured to cause the output interface to provide one of a plurality of different possible physical indications depending upon the traffic instruction.

20. The apparatus of claim 19, wherein the output interface includes a visual indicator, and wherein a first one of the plurality of different possible physical indications includes the visual indicator emitting a first color, and a second one of the plurality of different possible physical indications includes the visual indicator emitting a different second color.

21. The apparatus of claim 19, wherein the output interface includes an audible indicator, and wherein the plurality of different possible physical indications includes the audible indicator emitting a sound.

22. The apparatus of claim 15, further including a receiver configured to receive a wireless signal, and wherein the controller is further configured to determine the location of the apparatus based on the wireless signal.

23. The apparatus of claim 22, wherein the wireless signal comprises global positioning system (GPS) signals emitted from GPS satellites.

24. The apparatus of claim 15, further comprising a sensor coupled to the controller and configured to sense a magnitude of a physical force, wherein the traffic notification includes a representation of the magnitude of the physical force.

25. The apparatus of claim 15, wherein the controller is further configured to determine a direction of travel of the apparatus, and wherein the traffic notification includes an indication of the direction of travel.

26. The apparatus of claim 15, wherein the data further represents a plurality of directions of travel associated with the alert areas, wherein the controller is further configured to determine a direction of travel of the apparatus, and wherein the controller is further configured to compare the direction of travel with the stored data and to cause the transmitter to wirelessly transmit the traffic notification responsive to an outcome of comparing the direction of travel with the stored location data.

27. The apparatus of claim 15, wherein the apparatus includes a cellular telephone, and wherein the transmitter is a cellular phone network transmitter.

28. The apparatus of claim 15, wherein the traffic notification includes a representation of at least one of a vehicle weight and a tire pressure.

29. An apparatus, comprising:
means for determining a location of the apparatus;
means for comparing the determined location with stored data representing a plurality of alert areas; and
means for wirelessly transmitting a traffic notification associated with the determined location.

30. A method, comprising:
wirelessly receiving a traffic notification associated with a location of a mobile unit;
determining a criterion associated with the traffic notification;
evaluating the criterion; and
wirelessly transmitting a first traffic instruction to the mobile unit having a content based on an outcome of evaluating the criterion.

31. The method of claim 30, wherein the traffic notification indicates an alert area, the method further comprising comparing a stored plurality of alert areas with the alert area indicated by the traffic notification.

32. The method claim 30, wherein wirelessly transmitting includes wirelessly transmitting the first traffic instruction to the mobile unit to either proceed or not proceed based on the outcome of evaluating the criterion.

33. The method of claim 32, wherein, responsive to the outcome causing the first traffic instruction indicating not to proceed:
re-evaluating the criterion; and
wirelessly transmitting a second traffic instruction to proceed responsive to an outcome of re-evaluating the determined criterion.

34. An apparatus, comprising:
means for storing data associating a plurality of criteria with a plurality of alert areas;
means for wirelessly receiving a traffic notification indicating one of the alert areas;
means for determining one of the criteria associated with the indicated alert area;
means for evaluating the determined criterion;
means for choosing a traffic instruction based upon an outcome of evaluating the determined criterion; and
means for wirelessly transmitting the traffic instruction.

35. An apparatus, comprising:
a computer-readable storage medium configured to store data associating a plurality of criteria with a plurality of alert areas;
a receiver configured to wirelessly receive a traffic notification indicating one of the alert areas;
a transmitter; and
a controller coupled to the storage medium, the receiver, and the transmitter, and configured to determine one of the criteria associated with the indicated alert area, to evaluate the determined criterion, to choose a traffic instruction based upon an outcome of evaluating the determined criterion, and to cause the transmitter to wirelessly transmit the traffic instruction.

36. The apparatus of claim 35, wherein the controller is further configured to choose the traffic instruction to be either an indication to proceed or an indication not to proceed depending upon the outcome of evaluating the determined criterion.

37. The apparatus of claim 36, wherein the controller is configured to, responsive to the causing the transmitter to wirelessly transmit an indication not to proceed, re-evaluate the determined criterion and cause the transmitter to wirelessly transmit an indication to proceed responsive to an outcome of re-evaluating the determined criterion.
